(19) United States
(12) Patent Application Publication
(10) Pub. No.: US 2008/0041239 A1
(43) Pub. Date: Feb. 21, 2008

(54) MIXING STONE ASSEMBLY

(76) Inventors: Mark HOORWITZ, Hewlett, NY (US); Kenneth BERGMAN, Hewlett, NY (US)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/838,615

(22) Filed: Aug. 14, 2007

Related U.S. Application Data
(60) Provisional application No. 60/837,843, filed on Aug. 15, 2006.

(51) Int. Cl. A23G 9/22

(52) U.S. Cl. 99/455

(57) ABSTRACT

Mixing assembly for providing a cold work surface for mixing ice cream and toppings includes a base including a material capable of forming a cold reservoir after placement in a freezer and a mixing stone having a flat upper surface and retained on the base. The cold reservoir maintains the mixing stone at a low temperature and allows ice cream and toppings to be mixed thereon without the ice cream melting. The base includes a frame defining an interior compartment which includes or is receivable of the material and a depression into which the mixing stone is placed. The material in the compartment may be water which freezes when placed into a freezer for a sufficient amount of time, or any type of known freeze gel contained in a gel pack which, when placed into a freezer for a sufficient amount of time, is able to form a cold reservoir.

### CROSS REFERENCE TO RELATED APPLICATION

This application claims priority under 35 U.S.C. §119(e) of U.S. provisional patent application Ser. No. 60/837,843 filed Aug. 15, 2006, incorporated by reference herein.

### FIELD OF THE INVENTION

The present invention relates to a mixing stone assembly including a mixing stone which enables ice cream and similar frozen desserts to be mixed with toppings and other additives and is designed for home use.

### BACKGROUND OF THE INVENTION

It is now quite common to add toppings to ice cream or other frozen desserts to suit the consumer's desires and create unique and personal flavors. Such toppings include various flavored syrups, fruit, candy and confections such as chocolate chips and other chocolate products.

Accordingly, ice cream shops typically have a number of toppings available which can be added to the ice cream in a cup or cone upon request by the consumer, and specifically placed on top of the ice cream. One issue with this placement of toppings is that the consumer inherently first eats the ice cream at the top having the toppings thereon so that the remainder of the ice cream is eaten without the toppings, i.e., plain.

To address this issue, some ice cream shops mix toppings into the ice cream before it is served in a cup or cone so that the toppings are distributed throughout the ice cream. To allow for such mixing without the ice cream melting during the mixing process, the mixing is performed on a table having a stone top and which is maintained at a relatively cold temperature to inhibit melting of the ice cream. In use, a quantity of ice cream in one or more flavors selected by the consumer are placed onto the stone, along with the selected topping or toppings, and the ice cream and toppings are mixed together. Once a thorough mixing is achieved, the ice cream is removed from the stone and placed into a cup or cone and served to the consumer.

Unfortunately, the table having the stone top used in such ice cream shops is quite large and heavy and thus prohibitive for home use. A consumer is therefore unable to mix ice cream with toppings in a home setting without the ice cream melting during the mixing process.

It would be desirable to provide a mixing stone which enables ice cream and other frozen desserts to be mixed with toppings thereon and can be used in a home setting.

### OBJECTS AND SUMMARY OF THE INVENTION

It is an object of the present invention to provide a new and improved mixing assembly which can be used in a home setting to mix ice cream, or other frozen desserts, and toppings while inhibiting the ice cream or other frozen desserts from melting during the mixing process.

It is another object of the present invention to provide a new and improved mixing assembly having a mixing stone which is integrated with a portable base which maintains the mixing stone at a relatively cold temperature to enable ice cream, or other frozen desserts, and toppings to be mixed thereon.

In order to achieve at least one of these objects and possibly others, one embodiment of a mixing assembly capable of providing a cold work surface for mixing ice cream, or other frozen desserts, and toppings in accordance with the invention includes a base including or receivable of a material capable of forming a cold reservoir after placement in a freezer and a mixing stone having a substantially flat upper surface and being retained on the base. The cold reservoir provided by the material maintains the mixing stone at a low temperature and thereby allows ice cream and toppings to be mixed thereon without the ice cream melting.

In one embodiment, the base defines an interior compartment receivable of the material. The base may include a depression formed or surrounded by a peripheral or upwardly projecting wall, and the mixing stone is arranged in the depression. The base, peripheral wall, depression and mixing stone may be substantially rectangular.

To aid removal of the mixing stone from engagement with the base, the mixing stone may include at least one inwardly oriented indentation and the peripheral wall may include at least one notch aligning with a respective indentation.

Further, in one embodiment, a locking frame secures the mixing stone in engagement with the base and includes at least one inwardly oriented, arcuate projection arranged to substantially cover a respective indentation in the mixing stone. The locking frame seal spaces between edges of the mixing stone and the peripheral wall, and its projection enables its easy removal. Instead of the locking frame, other sealing and/or locking mechanisms may be used to achieve the same functions as locking frame.

The material in the compartment may be water which freezes when placed into a freezer for a sufficient amount of time to thereby form a cold reservoir. Alternatively, the material may be any type of known freeze gel contained in a gel pack which, when placed into a freezer for a sufficient amount of time, is able to form a cold reservoir. Such a gel pack is provided with a form complementary to the form of the compartment. The frozen water or gel pack in the compartment chill the mixing stone in view of the close positioning of the mixing stone to the compartment.

The mixing stone may be marble or granite and is preferably attached or sealed to the base. The mixing stone may alternatively be referred to as a mixing slab or mixing board.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a perspective view of a first embodiment of a mixing assembly in accordance with the invention;

FIG. 2 is an exploded view of the mixing assembly of FIG. 1;

FIG. 3 is a cross-section of the mixing assembly of FIG. 1 taken along the line 3-3;

FIG. 4 is a perspective view of a second embodiment of a mixing assembly in accordance with the invention;

FIG. 5 is a cross-section of the mixing assembly of FIG. 4 taken along the line 5-5; and

FIG. 6 is an enlarged view of the section designated 6 in FIG. 5.

### DETAILED DESCRIPTION OF THE INVENTION

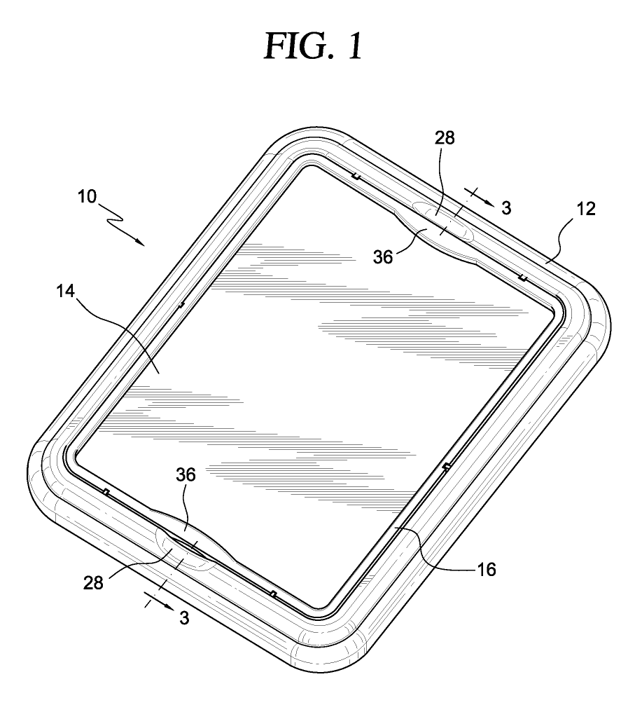

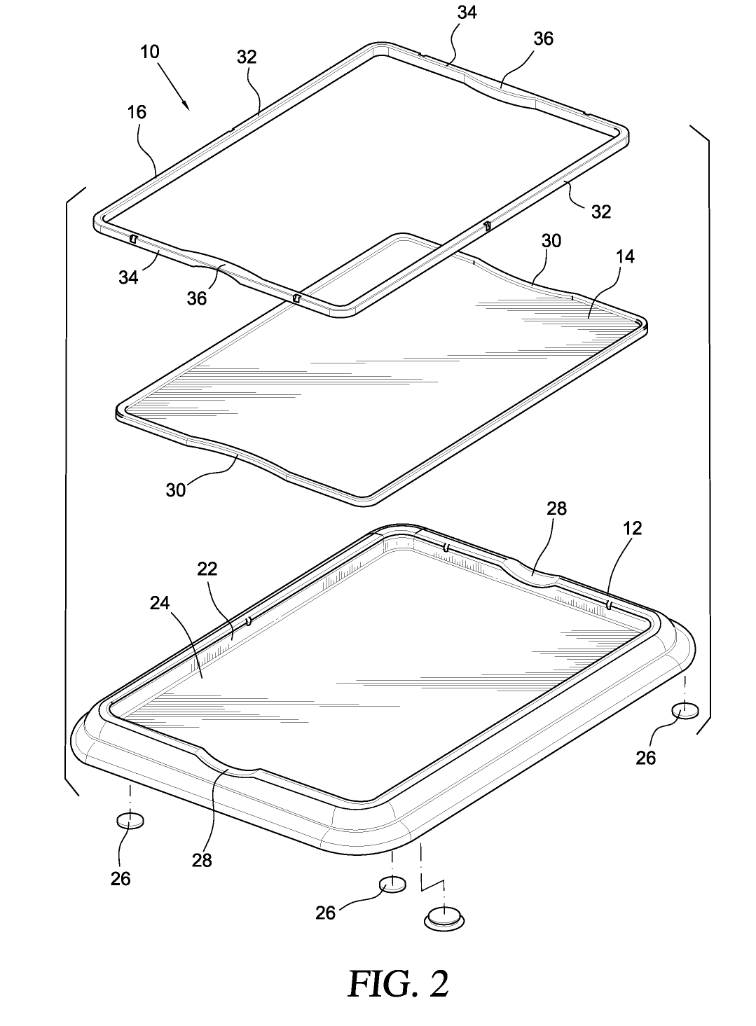

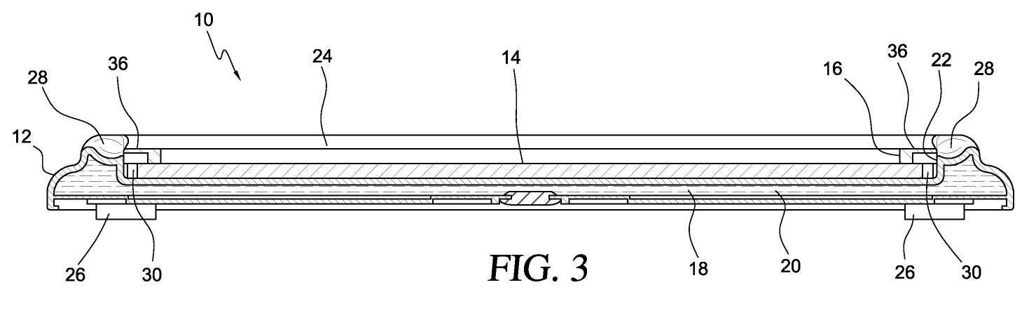

Referring the accompanying drawings wherein like reference numerals refer to the same or similar elements, a first embodiment of a mixing stone assembly in accordance with the invention is shown in FIGS. 1-3 and designated generally as 10 and comprises a base 12, a mixing stone 14 and a locking frame 16.

Base 12 defines an interior compartment 18 receivable of a fluid or other medium 20 and an upwardly projecting peripheral wall 22 defining a depression 24 into which the mixing stone 14 is placed.

Base 12 has a form which enables it to rest securely on a flat surface, e.g., either the bottom of the base 12 is substantially flat as shown or supports or pads or legs 26 extend downward from the bottom surface of the base 12. Notches 28 are formed in the peripheral wall 22, one along each shorter side thereof, to enable easy removal of the mixing stone 14.

In the illustrated embodiment, the base 12 is substantially rectangular and has rounded edges and corners. Approximate dimensions of the base 12 are a length of about 12 inches, a width of about 10 inches and a height of about 1 to about 1.5 inches. The depression 24 has a depth of about 0.5 inches so that the peripheral or perimeter wall 22 of the base 12 has a height of about 0.5 inches. The length of the depression 24 is about 11 inches and its width is about 9 inches.

Other shapes and sizes of the base 12 are envisioned and the rounding of the edges and corners of the base 12 is primarily for aesthetic purposes only and may be eliminated or altered as desired. Variations in the size, shape and rounding of the edges and corners may be necessitated by the manufacturing process and/or to accommodate existing packs of fluids.

The fluid 20 may be any fluid which freezes when placed into a freezer or is otherwise capable of forming a cold reservoir when placed into a freezer and exchanging thermal energy with a surrounding object when removed from the freezer (to draw thermal energy from the object and thereby cool the object). Thus, fluid 20 may be simply water placed into the compartment 18 or possibly a pack of a gel commonly used in ice packs. In the former case, to allow for expansion upon freezing, the compartment 18 is only partially filled with water. In the latter case, the gel pack is advantageously provided with a complementary form to part or all of the compartment 18.

To reduce manufacturing expenses, it would be advantageous to construct the base 12 with a compartment 18 having a particular size and shape to accommodate an existing gel pack. In this manner, an existing gel pack could be slid into the compartment 18 during manufacture of the base 12 and sealed therein.

Mixing stone 14 may be any substrate having a substantially flat, non-porous upper surface which is capable of being a work surface. The non-porosity or impermeability of the surface may be a function or property of the substrate itself or the result of a coating applied to a more porous substrate. Examples of substrates include various natural stones such as marble and granite.

Mixing stone 14 may have substantially the same size and dimensions as depression 24, or slightly less. Thus, in the illustrated embodiment, mixing stone 14 is substantially rectangular and may have a length of about 11 inches, a width of about 9 inches and a height no greater than 0.5 inches. In some embodiments, mixing stone 14 will have a height of about 0.25 inches.

Further, mixing stone 14 is provided with inwardly oriented indentations 30, one along each along the shorter sides, to enable the mixing stone 14 to be removed from the depression 24. Indentations 30 are formed so that they align with the notches 28 in the peripheral wall 22. Although the illustrated embodiment shows two notches 28 and two indentations 30, there may be only a single notch 28 and indentation 30, or more than two notches and respective indentations 30.

It is contemplated that different sizes and shapes of mixing stones 14 can be used in the invention, e.g., circular, square, oval, in which case, the peripheral wall would be formed with the same shape but slightly larger dimensions, and the depression 24 would be formed with substantially the same size and shape. Moreover, the mixing stone 14, peripheral wall 22 and depression 24 may have a different shape than the base 12, e.g., an oval depression 24 and oval mixing stone 14 for a rectangular base 12.

The locking frame 16 secures mixing stone 14 in depression 24 and thus in connection with the base 12. Locking frame 16 is substantially rectangular, or otherwise has the same shape as the mixing stone 14 and is the same size as or slightly larger than the mixing stone 14. Thus, locking frame 16 has a pair of opposed longer sides 32 and a pair of opposed shorter sides 34. On each shorter side, at an approximate central region, an inwardly oriented, arcuate projection 36 is formed. If the mixing stone includes only a single indentation 30, then there could only be a single projection 36 formed on the locking frame 16.

Projections 36 are dimensioned to substantially cover the indentations 30 in the mixing stone 14 (see FIG. 1), while also substantially sealing any spaces between the edges of the mixing stone 16 and the peripheral wall 22. Locking frame 16 may thereby secure the mixing stone 14 to the base 12 while ice cream and toppings, or other materials being mixed on mixing stone 14, are prevented from passing between the mixing stone 14 and the peripheral wall 22 into the depression 24.

To assemble the mixing assembly 10, the base 12 is first manufactured, and then the mixing stone 14 is inserted into the depression 24 and sealed or locked thereto. If locking frame 16 is the sealing or locking mechanism, the sides 32, 34 of the locking frame 16 are pressed into the spaces between the mixing stone 14 and the peripheral wall 22.

Manufacture of base 12 depends on the type and form of fluid used. Generally, base 12 is made of plastic and can be manufactured by any known plastic manufacturing technique. If the fluid is water, a quantity of water is introduced into the plastic base 12 prior to sealing of the compartment 18. If the fluid is contained in a gel pack, then the gel pack is first manufactured and then inserted into compartment 18 prior to sealing of the compartment 18. The thickness of the plastic of the base 12 is selected to ensure that the water can freeze or gel pack can transfer thermal energy through the plastic when in a freezer and thereby form a cold reservoir.

In use, the consumer would have to place the mixing assembly 10 into a freezer until the fluid or gel pack in the compartment 18 freezes. The exact time can be indicated on the packaging or with instructions on how to use the mixing assembly 10. The consumer would remove the mixing assembly 10 from the freezer and place ice cream and toppings onto the mixing stone 14. The ice cream and toppings would be mixed while on the mixing stone 14 without the ice cream melting since the mixing stone 14 is maintained at a temperature low enough to inhibit the ice cream from melting. Specifically, the frozen fluid or gel pack in close proximity to the mixing stone 14 ensures that the mixing stone is cold enough to prevent the ice cream from melting during the mixing process. When the mixing stone 14 is no longer cold enough to inhibit the ice cream from melting or the consumer is finished mixing ice cream and toppings together, the mixing assembly 10 can be placed back into the freezer to prepare it for the next use.

To clean the mixing assembly 10, the locking frame 16 is first removed by grasping the projections 36 and lifting the locking frame 16 out of engagement with the mixing stone 14. This is facilitated by the notches 28 in the peripheral wall 22 of the base 12, which align with the projections 36. The mixing stone 14 is then grasped by the indentations 30 and lifted out of engagement with the base 12, again facilitated by the presence of the notches 28 in the peripheral wall 22 which align with the indentations 30. The base 12, mixing stone 14 and locking frame 16 can be separately cleaned and then replaced in the reverse order.

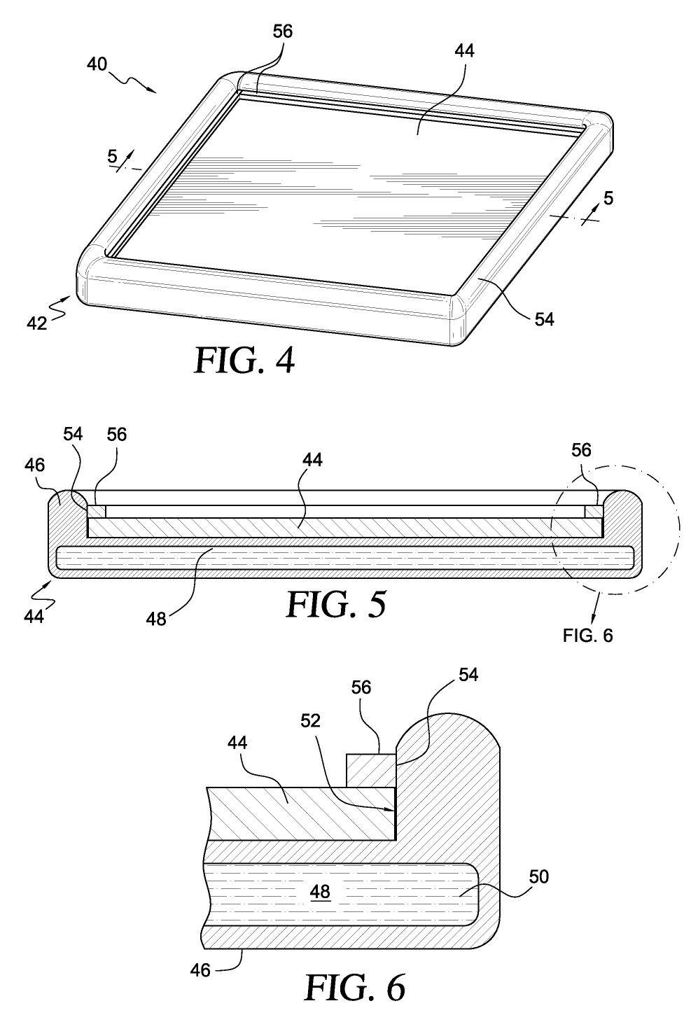

Referring now to FIGS. 4-6, a second embodiment of a mixing stone assembly in accordance with the invention is designated generally as 40 and comprises a base 42 and a mixing stone 44.

Base 42 has a frame 46 defining an interior compartment 48 receivable of a fluid or other medium 50 and a depression 52 in an upper surface into which the mixing stone 44 is placed.

Frame 46 has a form which enables it to rest securely on a flat surface, e.g., either the bottom of the frame is substantially flat as shown or supports or legs extend downward from the bottom surface of the frame 46 (not shown). In the illustrated embodiment, the frame 46 is substantially rectangular and has rounded edges and corners. Approximate dimensions of the frame 46 are a length of about 12 inches, a width of about 10 inches and a height of about 1.5 inches. The depression 52 has a depth of about 0.5 inches so that a perimeter wall 54 is formed by the frame 46 having a height of about 0.5 inches and the height of the compartment 48 is generally about 1.0 inches. The length of the depression 52 is about 11 inches and its width is about 9 inches so that the perimeter wall 54 has a thickness of about 0.5 inches along the upper, lower and sides edges of the frame 46. Perimeter wall 54 has rounded top edges and is preferably solid as shown in FIGS. 5 and 6. Perimeter wall 54 serves as a buffer to prevent a knife or other sharp object from puncturing the frame 46 to destroy the seal of the compartment 48 and cause a leak of the fluid 50 from the compartment 48.

Other shapes and sizes of the frame 46 are envisioned for the frame 46 and the rounding of the edges and corners of the frame 46 is primarily for aesthetic purposes only and may be eliminated or altered as desired. Variations in the size, shape and rounding of the edges and corners may be necessitated by the manufacturing process and/or to accommodate existing packs of fluids.

To prevent the base 42 from sliding during use, a rubberized coating may be applied to or integrated into the bottom surface of the frame 46.

The fluid 50 may be any fluid which freezes when placed into a freezer or is otherwise capable of forming a cold reservoir when placed into a freezer and exchanging thermal energy with a surrounding object when removed from the freezer (to draw thermal energy from the object and thereby cool the object). Thus, fluid 50 may be simply water placed into the compartment 48 or possibly a pack of a gel commonly used in ice packs. In the former case, to allow for expansion upon freezing, the compartment 48 is only partially filled with water. In the latter case, the gel pack is advantageously provided with a complementary form to part or all of the compartment 48.

To reduce manufacturing expenses, it would be advantageous to construct the frame 46 with a compartment 48 having a particular size and shape to accommodate an existing gel pack. In this manner, an existing gel pack could be slid into the compartment 48 during manufacture of the frame 46 and sealed therein.

Mixing stone 44 may be any substrate having a substantially flat, non-porous upper surface which is capable of being a work surface. The non-porosity or impermeability of the surface may be a function or property of the substrate itself or the result of a coating applied to a more porous substrate. Examples of substrates include various natural stones such as marble and granite.

Mixing stone 44 may have substantially the same dimensions as depression 52, or slightly less. Thus, in the illustrated embodiment, mixing stone 44 may have a length of about 11 inches, a width of about 9 inches and a height no greater than 0.5 inches. In some embodiments, mixing stone 44 will have a height of about 0.25 inches.

It is contemplated that different sizes and shapes of mixing stones 14 can be used in the invention, e.g., circular, square, oval, in which case, the depression 52 would be formed with substantially the same size and shape. Moreover, the mixing stone 44 and depression 52 may have a different shape than the frame 46, e.g., an oval depression 52 and oval mixing stone 44 for a rectangular frame 46.

To secure mixing stone 44 in depression 52 and thus in connection with the frame 46, the base 42 includes a sealing system. In the illustrated embodiment, the sealing system comprises edge members 56 which are placed along the edges of the mixing stone 44 and fixed to the frame 46, and specifically the perimeter wall 54 thereof. Mixing stone 44 is thereby secured to the base 42 while ice cream and toppings are prevented from passing between the mixing stone 44 and the edge members 54 into the depression 52.

To assemble the mixing assembly 40, the base 42 is first manufactured, and then the mixing stone 44 is inserted into the depression 52 and sealed thereto. If edge members 56 are the sealing mechanism, the edge members 56 are attached to the base 42.

Manufacture of base 42 depends on the type and form of fluid used. Generally, frame 46 is made of plastic and can be manufactured by any known plastic manufacturing technique. If the fluid is water, a quantity of water is introduced into the plastic frame 46 prior to sealing of the compartment 48. If the fluid is contained in a gel pack, then the gel pack is first manufactured and then inserted into compartment 48 prior to sealing of the compartment 48. The thickness of the plastic of the frame 46 is selected to ensure that the water can freeze or gel pack can transfer thermal energy through the plastic when in a freezer and thereby form a cold reservoir.

In use, the consumer would have to place the mixing assembly 40 into a freezer until the fluid or gel pack in the compartment 48 freezes. The exact time can be indicated on the packaging or with instructions on how to use the mixing assembly 40. The consumer would remove the mixing assembly 40 from the freezer and place ice cream and toppings onto the mixing stone 44. The ice cream and toppings would be mixed while on the mixing stone 44 without the ice cream melting since the mixing stone 44 is maintained at a temperature low enough to inhibit the ice cream from melting. Specifically, the frozen fluid or gel pack in close proximity to the mixing stone 44 ensures that the mixing stone is cold enough to prevent the ice cream from melting during the mixing process. When the mixing stone 44 is no longer cold enough to inhibit the ice cream from melting or the consumer is finished mixing ice cream and toppings together, the mixing assembly 40 can be placed back into the freezer to prepare it for the next use.

Mixing assembly 10, 40 can be packaged together with one or more mixing utensils and optionally with one or more toppings. Alternatively, the mixing assembly 10, 40 can be packaged with only one or more toppings without any mixing utensils. Mixing utensils would be packaged separately.

While particular embodiments of the invention has been shown and described, it will be obvious to those skilled in the art that changes and modifications may be made without departing from the invention in its broader aspects, and, therefore, the aim of this application is to cover all such changes and modifications as fall within the true spirit and scope of the invention. For example, the mixing stone may be sealed to the base so that the mixing assembly in its entirety is placed into the freezer, or alternatively, a mixing stone can be used which is removable from the base so that only the base is placed into the freezer and the mixing stone inserted or otherwise placed into connection with the base prior to use. Another variation is where the base is designed to accommodate a removal cold reservoir, e.g., a removal gel pack. In this case, only the gel pack is placed into the freezer and is inserted into the base prior to use. Another variation is to arrange an electrically activated cooling coil in the base, in proximity to the mixing stone, and for use, plug in an electric cord connected to the cooling coil. This activates the cooling coil which provides for continuous cooling of the mixing stone. The cooling coil could also simply be placed underneath and/or around the mixing stone. In another alternative embodiment, the base includes or is receivable of a material which is capable of forming a cold reservoir without having been previously placed into a freezer, e.g., dry ice or a similar compound.

1. A mixing assembly capable of providing a cold work surface, comprising:
a base including or receivable of a material capable of forming a cold reservoir after placement in a freezer; and
a mixing stone having a substantially flat upper surface and being retained on said base,
whereby the cold reservoir provided by the material maintains said mixing stone at a low temperature.

2. The assembly of claim 1, further comprising a locking frame for securing said mixing stone in engagement with said base.

3. The assembly of claim 1, wherein said base defines an interior compartment receivable of the material.

4. The assembly of claim 1, wherein said base includes a depression, said mixing stone being arranged in said depression.

5. The assembly of claim 4, wherein said base includes a peripheral wall around said depression.

6. The assembly of claim 5, wherein said base, said peripheral wall, said depression and said mixing stone are substantially rectangular.

7. The assembly of claim 5, wherein said mixing stone includes at least one inwardly oriented indentation and said peripheral wall includes at least one notch aligning with a respective one of said at least one indentation to enable said mixing stone to be easily removed from said depression.

8. The assembly of claim 7, further comprising a locking frame for securing said mixing stone in engagement with said base, said locking frame including at least one inwardly oriented, arcuate projection arranged to substantially cover a respective one of said at least one indentation in said mixing stone.

9. The assembly of claim 8, wherein said locking frame is further arranged to seal spaces between edges of said mixing stone and said peripheral wall.

10. The assembly of claim 1, wherein said upper surface of said mixing stone is non-porous.

11. The assembly of claim 1, wherein said base includes a bottom surface and a rubber coating arranged on said bottom surface to prevent unintentional movement of said base.

12. The assembly of claim 1, wherein said mixing stone has substantially the same circumferential shape as said base.

13. The assembly of claim 1, wherein the material is water.

14. The assembly of claim 1, wherein the material is a freeze gel arranged in a sealed gel pack.

15. The assembly of claim 1, wherein said mixing stone is marble or granite.

16. The assembly of claim 1, wherein said base includes sealing means for sealing said mixing stone to said base.

17. The assembly of claim 1, wherein said sealing means comprise edge members arranged over and alongside edges of said mixing stone and being attached to adjacent portions of said base.

18. A mixing assembly capable of providing a cold work surface, comprising:
a base receivable of a material capable of forming a cold reservoir after placement in a freezer;
a mixing stone having a substantially flat upper surface and being retained on said base; and
a locking frame for securing said mixing stone in engagement with said base,
whereby the cold reservoir provided by the material when received in said base maintains said mixing stone at a low temperature.

19. The assembly of claim 18, wherein said base includes a depression and a peripheral wall around said depression, said mixing stone being arranged in said depression.

20. A mixing assembly capable of providing a cold work surface, comprising:
a base receivable of a material capable of forming a cold reservoir after placement in a freezer, said base including a depression and a peripheral wall around said depression, said peripheral wall including at least one notch;
a mixing stone having a substantially flat upper surface and being arranged in said depression of said base; and
means for removably securing said mixing stone in engagement with said base while enabling easy removal of said mixing stone from engagement with said base, said means including a frame arranged inward of said peripheral wall and to surround said mixing stone, said frame including at least one inwardly oriented, arcuate projection aligning with a respective one of said at least one notch on said peripheral wall,
whereby the cold reservoir provided by the material when received in said base maintains said mixing stone at a low temperature.
